(19) United States
(12) Patent Application Publication
(10) Pub. No.: US 2005/0019195 A1
(43) Pub. Date: Jan. 27, 2005

(54) Rotary piston pump

(76) Inventor: Peter Schnabl, Munchen (DE)

Correspondence Address: MCCORMICK, PAULDING & HUBER LLP, CITY PLACE II, 185 ASYLUM STREET, HARTFORD, CT, 06103, US

(21) Appl. No.: 10/496,090

(22) PCT Filed: Nov. 19, 2002
(86) PCT No.: PCT/EP02/12960

(30) Foreign Application Priority Data
Nov. 20, 2001 (DE) 101 56 835.5

(51) Int. Cl. F03C 2/00

(52) U.S. Cl. 418/68

(57) ABSTRACT

The invention relates to a rotary piston pump comprising a housing (10), an annular piston (18) in the form of a tubular segment, which is connected to a shaft (22) in a rotationally fixed manner and which is guided rotationally and displaceably in an annular chamber (28, 10) of the housing, said chamber being coaxial with the shaft (22). The rotary piston pump also comprises at least one inlet and one outlet which are configured in the housing in such a way that the inlet or outlet on the annular chamber side are located inside an axial area of a surface area of the annular chamber, said surface area being determined by the maximum axial distance of the wave troughs of the end surfaces that face each other. The invention is characterized in that the annular piston has control pockets which are open toward its axial end surface, said control pockets controlling the inlets and outlets, wherein the characteristics of the control pockets (38) and the inlets and outlets are selected in such a way that maximum volume flow of the medium to be conveyed is enabled by the inlet (40) when the piston performs a stroke between the top and bottom dead center and by the outlet (56) when the piston performs a stroke between the bottom and top dead center.

The invention concerns a rotary piston pump with a housing, an annular piston in the form of a tubular segment which is rotatably connected to a rotatable shaft in the housing and is rotatable in an annular space of the housing coaxial with the shaft and with regard to which space it is rotatably and axially shiftably guided. The axial end faces of the annular space and of the annular piston which face one another are formed as wave surfaces with amplitudes parallel to the axis and with at least one wave crest and one wave trough. At least one inlet channel and one outlet channel are so formed in the housing that the inlet opening and the outlet opening adjacent the annular space lie within an axial region of the annular space outer surface which region is defined by the maximum axial spacing of the end surfaces that face one another.

One such rotary piston pump is known from DE 199 53 168 A. In this known rotary piston pump, the inlet and outlet openings are controlled by the contour of the wave surface of the annular piston. In this case it had been shown that the opening cross section has to be made relatively small in order to be able to accomplish the input and output control of the medium to be pumped without additional control elements such as check valves. It has been further shown that changes of the opening cross section by the combined stroke and rotary motion of the piston as considered in regard to the rotation angle of the piston occur relatively slowly. Accordingly, in regard to the inlet side an optimal filling of the annular space is hindered at high rotational speeds by an increasing throttling effect. A further disadvantage arises in that at the lower dead center the inlet and outlet channels cannot be separated from one another. Without a supplemental check valve the medium to be delivered therefore flows during the passage of the annular piston through the lower dead center from the outlet side high pressure region back to the inlet region lying close to atmospheric pressure. The mentioned occurrences impair the conveying efficiency of the rotary piston pump or demand measures which complicate the construction of the rotary piston pump.

The invention has as its object the provision of a rotary piston pump of the aforementioned kind which while maintaining a most simple construction is so made that the conveying efficiency of the pump is considerably increased.

This object is solved in accordance with the invention in that the annular piston has control pockets opening onto the axial end surfaces of the annular space for controlling the inlet and outlet openings, and in that the position, shape and size of the control pockets and of the inlet and outlet openings are so chosen that the inlet opening upon a piston movement between the upper and lower dead centers and the outlet opening upon a piston movement between the lower dead center and the upper dead center permit a maximum volumetric flow of the medium to be delivered.

Constructional limitations make available for the freeing of the inlet and outlet openings only a definite rotational angle of the annular piston. By the provision of the control pockets it is possible to optimize the control of the opening cross sections in the sense that a most large portion of the opening cross section of an inlet opening is open during a most large portion of the available piston rotation angle in order to achieve a maximum volumetric flow of the conveyed material into the annular space. While then the contour of the wave surfaces of the annular space and of the piston can be chosen so as to obtain an optimal harmonic movement of the piston, the volumetric flow of the medium to be delivered through the inlet and outlet openings can be optimized by the choice of the shape and the position of the control pockets. Moreover, by the shape and position of the control pockets it can be assured that during the passage of the annular piston through its lower dead center center, that is, when the end surface of the annular piston has its maximum axial spacing from its associated end surface of the annular space, a sealing of the inlet openings and outlet openings from one another is assured so that no medium can pass between the openings. The use of additional valves is therefore not necessary.

Preferably the control pockets have at least substantially axis parallel control edges with the pocket bottoms at least substantially following the contour of the wave surface section lying between the control edges—as considered in the circumferential direction of the annular piston. By way of this formation of the control pockets the change of the opening cross section per angular travel of the annular piston is maximized, so that for the inflow and outflow of the medium to be conveyed the time available is used in an optimum way. For the same purpose it is proposed that the inlet opening have an axis parallel forward edge and rear edge (with reference to the rotational direction) and that the upper edge of the inlet opening near the wave surface of the annular space is so shaped that it substantially registers with the contour of the wave surface of the annular piston when the rearward control edge of a control pocket reaches the forward edge of the inlet opening, that is the inlet opening is closed. This shape of the inlet opening also takes into consideration that the annular piston not only carries out a rotational movement but also carries out an axial movement. Preferably the lower edge of the inlet opening remote from the wave surface of the annular space follows at least substantially the movement path of the forward lower corner of a control pocket during the movement of annular piston from the upper dead center center to the lower dead center center.

To optimally use the rotational angle or time period standing available for the inflow of the medium to be conveyed, it is advantageous in the case of a wave surface shape with two wave crests and two wave troughs, if the width of the inlet opening as measured in the circumferential direction of the piston and the width of the control pockets are so related to one another that the inlet opening is opened through-out the complete stroke of the annular piston between the upper dead centercenter and the lower dead center center.

The control of the cross section of the outlet opening is, for the total volumetric through-put, less critical than the control of the cross section of the inlet opening. Preferably however the outlet opening is also so formed that its rear edge is arranged substantially axis parallel, that a first section of an upper edge of the outlet opening connected to the rear edge of the outlet opening is arranged parallel to the wave surface of the annular piston when the forward control edge of a control pocket reaches the rear edge of the outlet opening, and that a second section of the upper edge of the outlet opening connected to the first section follows the contour of the control pocket edge when the annular piston reaches the upper dead center center.

In the use of a rotary piston pump of the previously mentioned kind it is, depending on circumstances, desirable to change the delivery volume of the pump while keeping the rotational speed constant or on the other hand to keep the delivered volume constant with constantly changing rotational speed of the annular piston. The latter case occurs for example in the use of such rotary piston pump in the automotive industry when the pump is directly driven by the vehicle engine whose rotary speed constantly changes in operation, while simultaneous changes of the delivery volume are not desired. In order to solve these objects in the simplest way, according to the invention it is proposed that two annular space/annular piston arrangements are so arranged co-axially relative to one another that the pistons arranged on the same shaft move in common between the end faces of the two annular spaces, the two annular spaces being connected with one another by way of a fluid connection lying radially within the annular piston, the radially inner wall of each annular space beingformed by the outer surface of a control sleeve which is arranged rotationally fixed and axially shiftable in the housing and is adjustable by means of a control drive between an axially inner position in which it closes the fluid connection and an axially outer position at which it at least partially opens the fluid connection.

This solution offers the possibly that the delivered volume of the pump can be controlled in that a more or less greater portion of the volume is pumped back and forth between the two annular spaces, that is, it is not ejected outwardly from the pump. If the fluid connection is closed by the control sleeves the pump produces its maximum delivered volume. On the other hand if the cross section of the fluid connection is more or less open more or less fluid will be delivered outwardly from the pump. The opening cross section of the fluid connection can be so chosen that upon maximum opening of the fluid connection, no medium is ejected outwardly, that is the pump delivers nothing. If the pump is for example driven by an automobile engine whose rotational speed in operation changesvery frequently, by the axial shifting of the control sleeves a very fast and sensitive reaction to such rotational speed changes can take place, and in this way the delivered volume of the pump can be held constant despite the changing rotational speed.

Advantageously the control sleeves are adjustable between their axially inner and outer end positions in a stepless manner. Basically the axially inner ends of the control sleeves can serve as, control edges on the control sleeves. To allow for the axial movement of the annular piston during a rotation, it is advantageous if the control sleeves have at least one axis parallel control slot which makes the opening or the control of the fluid connection independent of the axial movement of the annular piston. Advantageously in the case of the previously described solution the outlet and inlet openings are formed in the respective radially outer wall of the annular spaces to assure a most simple construction of the pump. Therefore the two annular pistons in a way known in itself can be unified into a single one-piece double piston.

To assure for high rotational speeds the required quiet and low wear running of the rotary piston pump of the invention the annular piston should execute harmonic oscillations in the axial direction. That means that the apex point of the piston contour, that is, the peak of the wave crest—in consideration of one cycle—follows the function:
Y=A·cos x (1)
where y is the axial stroke of the piston and x is the rotational angle of the piston. In order to achieve the previously given aim, according to the invention it is proposed that the contour of the wave surface of the annular space—in considering one cycle—lie in a region enclosed by the functions
y=cos x (2)
and

$$y = cos ( x - arccos \sqrt{\frac{cos x + 1}{2}} ) + \sqrt{\frac{cos x + 1}{2}} - 1 \qquad ( 3 )$$

with the contours of the two wave surfaces which slide relative to one another being so chosen that the wave surfaces, at least in the area in which they are guided by one another or engage one another with the piston rotation, are continuous. While on first appearance it seems obvious to shape both of the wave surfaces facing one another in the form of pure sinusoidal surfaces, practice has shown that in the case of such a solution the pistons can never rotate uniformly and smoothly. With the reaching of the upper dead center center the two wave surfaces come to lie entirely on one another. To move the piston further from this position a special force and therewith a jerky change of the acceleration is necessary. This in turn means that the piston not only runs extremely unsteadily, but is also subject to high wear is experienced. This wear is minimized with the described solution in that the contours of the wave surfaces always engage only at one point which moreover with one rotation of the annular piston wanders back and forth about the associated apex point of the piston contour.

In the previously given equations (2) and (3) the amplitude factor for simplicity purposes is set as being equal to 1. A can obviously have a greater or lower value.

In practice after the determination of the contour of the wave surface of the annular space the piston contour is so designed that it produces a harmonic movement of the piston. With this the contours of the two wave surfaces which slide relative to one another are preferably so designed with respect to one another that in the most wear critical region, when the apex point of piston contour passes over the apex point of the contour of the wave surface of the annular space, the sum of the wear of the surfaces guided on one another is as low as possible, as is later explained in more detail.

In a modified embodiment of the invention the rotary piston pump is so constructed that in the wave surface of the annular piston in the region of the apex point of a wavecrest, a rolling body, for example a roll, a ball or a cone, extends outwardly beyond the wave surface and is supported by a rotational axis arranged radially to the piston axis, with the contour of the wave surface of the annular space being so chosen that—in consideration of one cycle—the support middle point of the rolling body runs according to the curve given by the function y=A·cos x and the contact point between the annular piston and the end face of the annular space during one piston rotation constantly lies on the circumference of the roll body. That means that the annular piston is not slidingly guided on the wave surface of the annular space or stator, but instead rolls with the rolling body on the wave surface of the annular space or stator, while it rotates about its axis. This solution can be especially advantageous when the rotary piston pump is used to pump non-lubricating liquid media or gaseous materials. In this case an improved wear resistance is obtained since the relative movement between the annular piston and the stator is essentially taken up by the support of the rolling body. Instead of being supported by the annular piston the respective rolling body can also be supported in the stator wave surface.

The previously described condition for the shape of the wave surface contour of the annular space is satisfied by a line whose distance from the path curve of the support middle point of the rolling body described by the function y=A·cos x at each point is equal to the rolling body radius. In this case it is assured that the axial movement of the annular piston corresponds to an harmonic oscillation.

For the modified embodiment it also applies that A in the formula y=A·cos x can take any desired value.

Further features and advantages of the invention will be apparent from the following description, which in combination with the accompanying drawings explain the invention by way of exemplary embodiments. The drawings are:

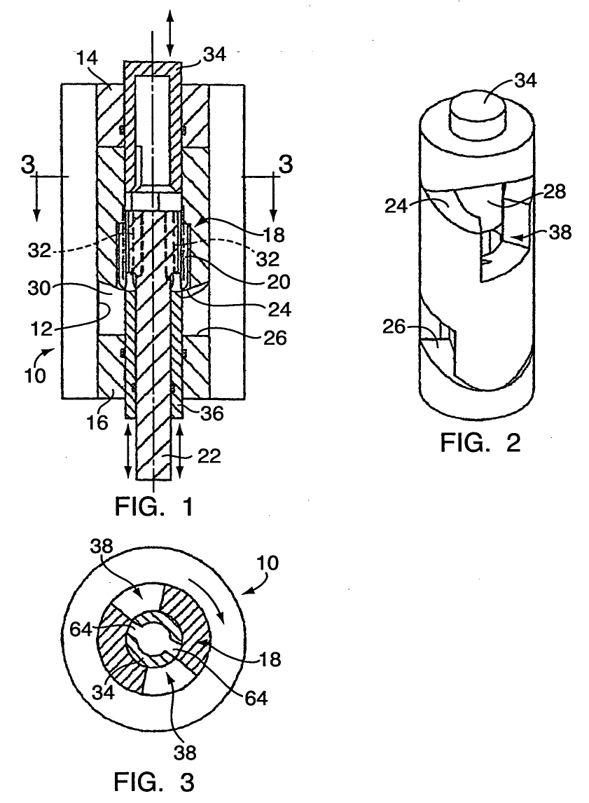

FIG. 1 a cross section in schematic form taken along the axis of a rotary piston pump embodying the invention,

FIG. 2 a perspective illustration of the rotary piston lying between the end surfaces of the annular spaces of the rotary piston pump illustrated in FIG. 1 without the housing,

FIG. 3 a section taken along the line III-III of FIG. 1,

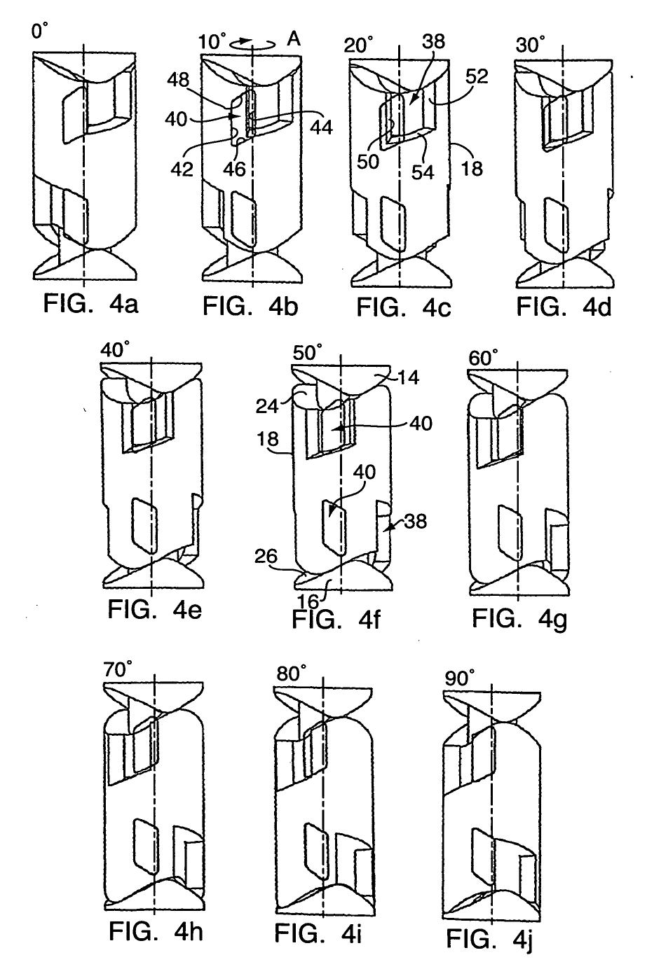

FIG. 4 a schematic illustration of the rotary piston lying between the end faces of the annular spaces with schematically illustrated inlet openings in 10 different angular positions of the piston spaced 10° from one another between 0° and 90°,

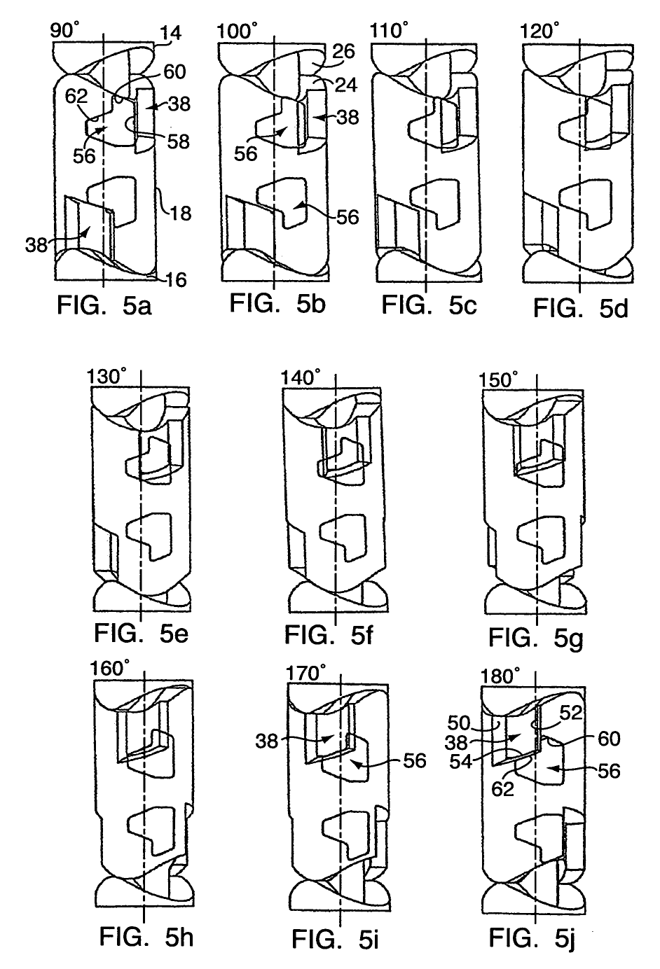

FIG. 5 a illustration corresponding to FIG. 4 of the rotary piston with the schematically illustrated outlet openings in 10 different angular positions of the piston spaced 10° from one another between 90° and 180°,

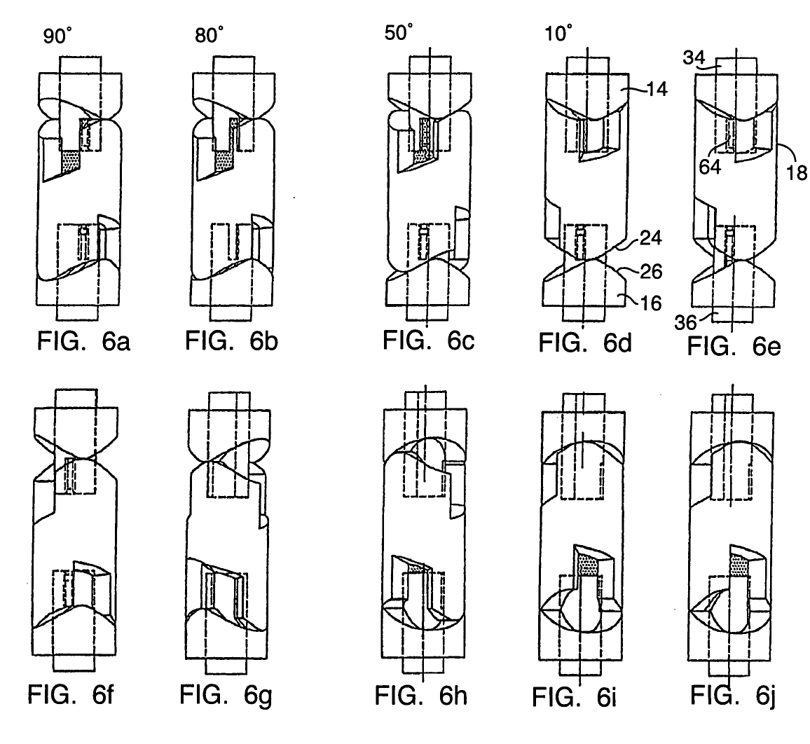

FIG. 6 schematic illustrations corresponding to FIGS. 4 and 5 of the rotary or annular piston in different angular positions to explain the regulation of the delivered volume, wherein the control sleeves are shown in an axially outer position,

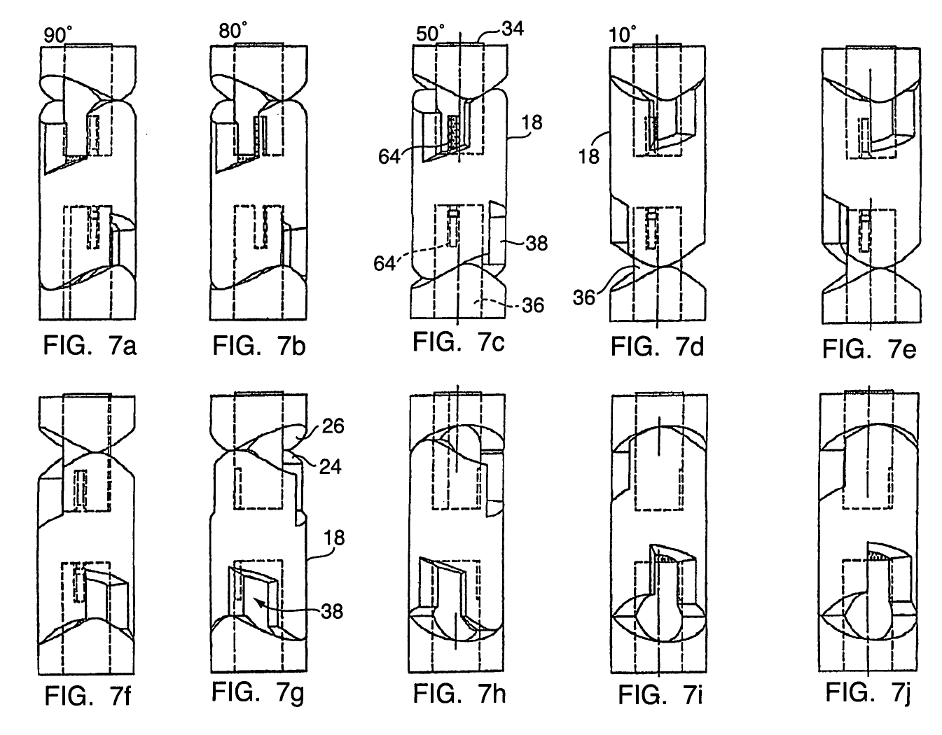

FIG. 7 an illustration corresponding to FIG. 6 with the control sleeves in an axial middle position,

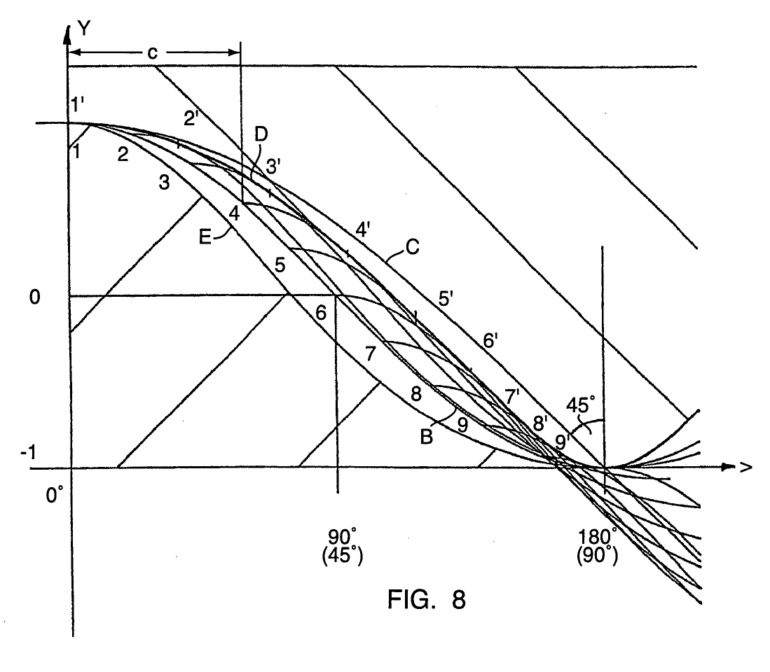

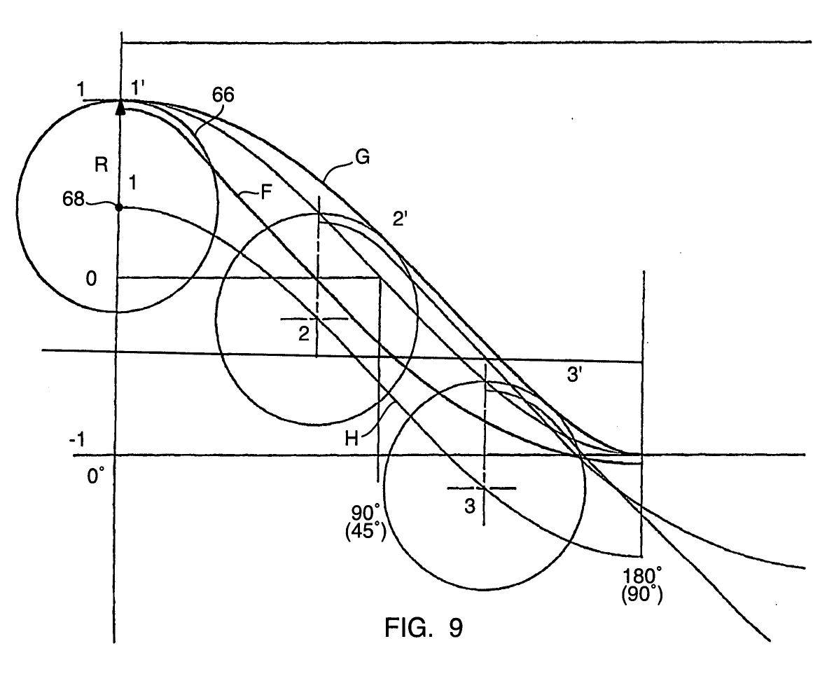

FIG. 8 a graphic illustration for explaining the shape of the contour of the wave surfaces of the annular piston and of the associated annular spaces, and

FIG. 9 a graphic illustration for explaining the shape of the contour of the wave surfaces of the annular piston and of the associated annular space in a modified embodiment of the invention.

### DETAILED DESCRIPTION OF THE PREFERRED EMBODIMENTS

FIG. 1 is a cross sectional view in schematic form taken along the axis of a rotary piston pump embodying the invention and having a cylindrical housing 10, whose cylindrical bore 12 is closed by end pieces 14 and 16. A tube-shaped annular piston 18 is supported in the space enclosed between the end pieces 14 and 16. The piston by means of a linear bearing 20 is rotatably fixed but axially slidably connected with a shaft 22 which passes through the end piece 16 coaxial to the cylindrical housing 10. The annular piston 20 has at each of its axial ends a wave surface 24 which is guided on a wave surface 26 on the associated one of the end pieces 14 and 16. The so far described rotary piston pump is explained in more detail in DE 199 53 168 A1. For the basic functioning of this pump reference is made to this publication.

In the solution illustrated in FIG. 1 the annular space 28 lying between the wave surface 26 of the first end piece 14 and the wave surface 24 of the annular piston 18 facing it, and the annular space 30 lying between the wave surface 26 of the lower end piece 16 and the wave surface 24 of the annular piston 18 facing it are connected with one another by one or more channels 32 parallel to the axis, which are indicated in FIG. 1 by broken lines. These channels form a fluid connection between the two annular spaces 28 and 30. A first control sleeve 34 is arranged in the upper end piece 14 in a rotationally fixed but axially slidable manner. The control sleeve forms the radially inner boundary wall of the annular space 28. A second control sleeve 36 is arranged in the end piece 16 in a rotationally fixed but axially slidable manner and forms the radially inner boundary wall of the annular space 30. The two control sleeves 34 and 36 can be axially adjusted in the direction of the indicated double arrows by a non-illustrated positioning drive, so as in this way to close or to more or less open the channels 32, that is, the fluid connections between the annular spaces 28 and 30. The function of these control sleeves 34 and 36 will be explained in more detail later in connection with FIGS. 6 and 7.

In FIGS. 2 and 3 one sees that control pockets 38 are formed in the annular piston, each of which opens onto the associated wave surface 24. The pockets serve to control the inflow of the conveyed medium to and the outflow of that medium from the annular spaces 28 and 30, respectively. The shape of these control pockets and their cooperation with the inlet and outlet openings will now be explained in more detail in connection with FIGS. 4 and 5.

In the individual illustrations of FIG. 4 the inlet openings are indicated at 40 and each represents the outlet orifice of an inlet channel in the bore 12 of the housing 10. Each inlet opening 40 has—with reference to the rotational direction of the annular piston 18—a forward edge 42 and rear edge 44 which are parallel to the axis of the annular piston 18. The lower edge 46 and the upper edge 48 of each inlet opening are substantially parallel to the contour of the wave surface 24 of the annular piston 18 when the annular piston is in its 90°-position, as will be explained later.

The control pockets 38 likewise each have a forward edge 50 and a rear edge 52 running parallel to the axis of the annular piston. Each pocket 38 is open toward the wave surface 24. The bottom 54 of the pocket runs substantially parallel to the contour of the wave surface 24 between the edges 50 and 52.

In the following only the upper portion of the double piston pump illustrated in FIG. 4 will first be taken into consideration. At 0° the annular piston 18 is at its upper dead center. In this position, the forward edge 50 of the control pocket 38 is registered with the rear edge 44 of the inlet opening 40. Accordingly, the entire height of the inlet opening stands available for cross sectional change when the annular piston 18 leaves the upper dead center and rotates in the direction of the arrow A to the 10°-position. In the further course of the piston rotation, the lower edge of the control pocket 38 follows substantially the inclined lower edge 46 of the inlet opening 40, since with the rotation the annular piston 18 also moves axially downwardly. Between 30° and 60° the entire cross section of the inlet opening 40 stands available for the inflow of the medium. After 70° the rear edge of 52 of the control pocket 38 slides over the inlet opening 40. In the transition from 80° to the lower dead center at 90° the entire height of the inlet opening is again crossed by the closing piston edge. Because of the nearly equal axial lengths of the opening edges, in the opening and closing procedures there occurs nearly equal values of cross sectional change. At 90°,that is at the lower dead center, the inlet opening 40 is closed. The upper inclined edge of the inlet opening is nearly registered with the contour of the wave surface of the piston which meets the maximum upper position of the edge 48 of the inlet opening. The width of the inlet opening and the arc length of the control pocket are so related to one another that the timing of the opening of the inlet opening extends throughout the entire stroke of the annular piston 18 between the upper dead center, and the lower dead center, that is throughout the rotational angle of 90°. This portion of the piston movement corresponds therefore to the suction stroke in the upper annular space 28 which thereby becomes filled with the conveyed medium.

In the movement of the annular piston 18 from its lower dead center (90°) back to the upper dead center (180°) the sucked in fluid is now pushed out. This is illustrated in FIG. 5. In FIG. 5 the contour of the outlet opening 56 is illustrated.

The contour of the outlet opening results from the constructional requirements posed by the inlet side. At 90° (lower dead center) the outlet opening 56 is still closed. The rear edge 58 of the outlet opening 56 runs parallel to the axis of the rotary piston 8 and registers with the forward edge 50 of the control pocket 38. A first section 60 of the upper edge of the outlet opening 56 runs substantially parallel to the wave surface 24 at this region. If the piston is moved out of the lower dead center in the direction toward the 100°-position, one obtains thereby a maximum change in the opening cross section. The elongation, parallel to the axis, of the opening to the middle is determined by the control pocket depth respectively is adapted to the required minimum size of the resulting opening cross section in accordance with the demanded output of the pump. Between about 120° and 140° the outlet opening 56 has its maximum opening cross section. Then the outlet opening begins to close again. At the 180°-position, that is at the upper dead center, the outlet opening is entirely closed. One will understand that the second section 62 of the upper opening edge of the outlet opening 56 is suited to the course of the lower edge 54 of the control pocket 38.

It is seen in FIGS. 4 and 5 that the processes in respect to the lower annular space 30 are each shifted by 90°. In the 0°-position in FIG. 4 the lower input opening has just been closed and the expulsion of the fluid from the annular space 30 begins, as explained in connection with FIG. 5, while in FIG. 5 fluid is now sucked into the lower annular space 30.

In connection with FIGS. 6 and 7 it will now be explained how the flow of the fluid delivered from the pump can be regulated with the help of the control sleeves 34 and 36 illustrated in FIG. 1. FIG. 6 shows the annular piston in different rotational positions, with the control sleeves being constantly extended to the maximum. In these positions the volumetric throughput is practically 0. The pump delivers no fluid. On the other hand, when the control sleeves are maximally retracted, the pump delivers the maximum volume and behaves thereby in the same way as already known rotary piston pumps without this regulation by the control sleeves. FIG. 7 shows the pump with the control sleeves in a middle position.

In FIG. 7 each two respective superimposed representations of the pump belong together. The upper representation shows the relevant function of the upper angular space or the upper chamber, and the lower representation shows the relevant function of the lower chamber. At the upper dead center (FIG. 7, right illustration) the forward edge 50 of the control pocket 38 parallel to the axis registers with the rear edge of a slot 64 formed in the control sleeve 34 parallel to the axis. The upper chamber 28 is still inwardly, that is toward the connecting channels 32, closed. The lower chamber 30 is on the other hand connected, by way of a dotted line indicated cross section, with the channels 32. With a rotation of the piston by 10° (FIG. 7, second illustration from the right) the annular piston 18 opens an opening cross section to the inside. In this phase fluid flows into the upper chamber 28; the fluid volume expelled out of the lower chamber escapes into the interior of the pump and flows through the connecting channels 32 pressureless into the upper chamber 28.

At about 50° after the upper dead center (FIG. 7, middle) the lower chamber 30 is closed. The remaining stroke volume is compressed and expelled from the housing 10 through the outlet channels. The upper chamber 28 is hereafter open inwardly. Since the connection to the lower chamber 30 is interrupted the remainder of the suction volume is delivered from the inlet opening. This condition continues with further rotation of the piston to 80° after the upper dead center and to 90° after the upper dead center. After this the process repeats itself but with reversal of the cycles from the upper to the lower chambers.

In the case of the positions of the control sleeves 34 and 36 illustrated in FIG. 6 the sequence explained in connection with FIG. 7 is repeated with the difference that the openings of the lower chambers remain open inwardly during their entire compression stroke so that the fluid contained in them is delivered without pressure to the upper chamber 28 then in its intake condition. With these settings of the control sleeves 34 and 36 the complete fluid volume is exchanged between the upper and the lower chambers. No fluid flows into the pump and for the time being no fluid is ejected from the pump.

The control sleeves are not illustrated in their entirely pushed in positions. In these inward end positions no opening to the interior exists in the compression phase so that the entire stroke volume is delivered to the outlet. The suction chamber (corresponding to the upper chamber in FIGS. 6 and 7) is indeed open to the interior; however itdraws the complete fluid volume from the inlet since no other possibility exists.

In the described embodiment the control sleeves 34 and 36 are arranged so as to be rotationally fixed and shiftable only in the axial direction. This can be achieved for example through the use of a vertical guide groove which is not illustrated. Depending on circumstances it can become advantageous to support the axial movement with a rotational movement in order to achieve a corresponding desired drive relationship. This combined rotary—axial—movement can for example be achieved by a thread shaped groove in each control sleeve which receives a pin connected to the associated part 14 or 16.

The cross section of the connecting channels 32 is so chosen that at the highest rotational speed of the pump a practically throttling free exchange of the fluid volume between the two chambers is assured. For the positioning of the control sleeves 34 and 36 a common positioning motor can be used on both sides which converts the input signal (rotational speed or volumetric flow or system pressure or a combination of these three values) into a corresponding stroke position of the control sleeves. In this way, the conveying volume of the pump can be regulated in stepless fashion and, for example, can be held constant with variable rotational speeds.

A substantial advantage in contrast to known regulatable positive displacement pumps exists in that the adjustment of the control sleeves 34, 36 takes place without counter pressure. That means that the adjustment can take place with relatively small energy consumption and in relatively short time since the masses which are moved are relatively small.

By way of FIG. 8 the shape of the wave surfaces 24 and 26 will now be explained. The aim is to assure an harmonic kinematic movement progress of the annular piston 18 during pumping. The contours of the relatively slidable wave surfaces 24 and 26 of the annular piston (rotor) and of the end pieces 14 and 16 of the housing 10 (stator) are so designed that this movement progress is assured.

An harmonic kinematic movement progress of the piston is given if the translatory speed component of the piston fulfills the basic equation for the speed of harmonic oscillation.
v=A·ω·cos(ω·t)

This definition refers to a design in which the piston during one cycle carries out a simple sinusoidal oscillation. The derived relationships are exactly the same for a double oscillation if one on the time axis replaces the angle designated “ω·t” by “2·ω·t”.

The derivation of the formula mirror the relationships at the outer surface of the piston. This however is no prerequisite for the validity of the formula. What is important is that the derived relationships concerning the kinematic course can be uniformly transmitted to and used on the entire diameter of the piston.

The movement of the piston contour gives a functional course according to the equation
f(x)=y=A·cos(x)

An harmonic kinematic movement with respect to the piston stroke is then only given when apex point 1 (FIG. 8) of the piston upon a rotation of the piston follows the function y=cos x. A can have any desired value but for simplicity purposes in the following is set to be equal to 1. Since the piston does not only rotate (advancing of the contour in the X-direction) but also moves axially (movement of the piston in the y-direction), the sequence of positions of the piston contour are given by a group of curves according to the equation
f_{(x,c)}=y=cos(x−c)−(1−cos(c))

Since the piston is guided by the corresponding stator surface it can realize these movement courses from the upper dead center position only if the stator contour describes the envelope of the group of curves. The formula for the envelope reads

$$y = cos ( x - arccos \sqrt{\frac{cos x + 1}{2}} ) + \sqrt{\frac{cos x + 1}{2}} - 1$$

As one can understand from FIG. 8, the envelope cuts the line y=−1 (lower dead center axis) at an angle of 45°. Therefore in the illustrated case the stator curve must have at 180° an apex point with a angle of 90° (−45° to +45°) when the lower dead center is to lie at y=−1 and at φ=π=180°.

On the other hand the piston at its maximum (=apex point at φ=0 in FIG. 8) must have an apex, if the stator contour is formed according to the function f(x)=cos(x) and the piston throughout the entire stroke from y=+1 to y=−1 is to carry out an harmonic linear movement.

On grounds of a quiet uniform running and an optimized wear resistance, spikes on the stator or piston are not acceptable. Therefore it is recommended that a stator curve be chosen which lies between the two extremes, namely the function y=cos(x) (curve B in FIG. 8) and the function of the envelope (curve C in FIG. 8). An actual realistic stator curve is indicated in FIG. 8 at D and is within the region enclosed by the curves B and C.

It represents the envelope for the movement of the actual rotor curve E. In the FIG. 8, the movement of a piston with the contour E is reproduced by a group of curves 1-9. The piston thereby moves with its apex 1 on the curve B, which is reproduced by the function y=cos x. Accordingly the apex point runs through the different positions 1-9. The engagement points of the rotor contour corresponding to the apex points on the stator contour are illustrated and are indicated by the points 1′ to 9′ on the envelope D. At the upper dead center (x=0) the apex point 1 and the engagement point 1′ are identical. In the further course there results an advancement of the engagement point which in this construction reaches a maximum at position 6-6′ (φ=π/2). From φ=π/2 to φ=π the advancement slackens and at φ=π=180° the apex point and the engagement point again fall together.

The curve or contour E of the piston therefore lies below or maximally on the curve y=cos(x) and is in its shape so derived from the stator curve D that at each rotational angle φ the apex point 1 lies on the curve y=cos(x) and at the same time an engagement point for the stator curve is defined.

The choice of the two associated curves E and D is preferably such that in the most wear critical area, when the apex point of the piston contour sweeps over the apex point of the contour of the wave surface of the annular space, the sum of the wear of the surfaces guided on one another is as small as possible. In this region at about φ=180° the engagement point has it lowest angular speed, that is, the engagement point moves only relatively slowly both on the apex of the rotor resp. the piston contour as well as on the apex of the stator. Additionally here the opposed curvature relationships work negatively on the surface pressures. A shifting of the curve D from the position illustrated in FIG. 8 to the curve C means a lower wear of the piston at the expense of the stator, and a shifting of the curve D to the curve B means lower a wear of the stator at the cost of the piston.

The arrangement of the contours can as desired be exchanged between the piston and the stator.

FIG. 9 is concerned with the above-described modified embodiment in which the annular piston by its wave surface represented by the contour line F does not slide on the stator wave surface represented by the curve G but is guided on this by means of a roll 66. The roll 66 is freely rotatably supported in a non-illustrated slot formed in the wave surface of the annular piston for movement about a rotational axis directed radially with respect to the piston axis, which is indicated by the bearing middle point 68.

To achieve an harmonic axial movement of the rotary piston, the bearing middle point 68 during one rotation of the annular piston must run on a path curve H described by the function y=A ·cos x. With the assumption that the roll 66 during a piston rotation constantly engages the stator wave surface, one obtains the harmonic axial movement of the annular piston during a piston rotation if the contour G runs parallel to the curve H at a spacing of the roll radius R. Each point of the contour line G therefore lies on a normal to the curve y=cos(x) at a distance R.

The exact course of the piston contour F is not critical so long as it is assured that the contour is so far drawn backwardly that during rotation of the piston it cannot engage the stator contour G.

FIG. 9 also shows, like in FIG. 8, curves for the factor A always being equal to 1. It will be understood, that this factor can take on other desired values.

The present embodiments are further explained by arrangements which always show the outer most surface of the illustrated rotational body. In practice it is to be taken into consideration that the wave surfaces and also the roll 66 (rolling body) have a limited radial elongation (with reference to the piston axis). Thereby the pictured relationships are not changed in principle.

1. A rotary pump with a housing (10), an annular piston (18) in the form of a tubular segment which is rotatably fixedly connected to a rotatable shaft (22) in the housing (10) and which is rotatably and axially slidably guided in an annular space (28, 30) of the housing coaxial to the shaft (22), with axial end faces (26, 24) of the annular space (28, 30) and of the annular piston (18) which face one another being formed as wave surfaces with axis parallel amplitudes and with at least one wave crest and one wave trough, and with at least one inlet channel and one outlet channel so formed in the housing (10) that an inlet opening and an outlet opening, (40, 56) adjacent the annular space lie within an axial region of an annular space outer surface which axial region is determined by the maximum axial spacing of the end surfaces (24, 26) facing one another, characterized in that the annular piston (18) has control pockets (38) for controlling the inlet opening and the outlet opening (40, 56), which control pockets open onto the axial end face (26) of the annular space (28, 30), and in that the position, shape and size of the control pockets (38) and of the inlet opening and of the outlet opening (40, 56) are so chosen that the inlet opening (40) upon a piston movement between upper and lower dead centers and the outlet opening (56) upon a piston movement between the lower and the upper dead centers make possible a maximum volumetric flow of the medium to be conveyed.

2. A rotary piston pump according to claim 1, further characterized in that the control pockets (38) have control edges (50, 52) substantially parallel to the axis and in that the pocket bottoms (54) at least substantially follow the contour of the wave surface sections lying between the control edges (50, 52) in respect to the circumferential direction of the annular piston (18).

3. A rotary piston pump according to claim 1 or 2 further characterized in that the inlet opening (40) has forward edge and rear edge (42, 44) (in reference to the rotation direction A) parallel to the axis, and that the wave surface of the annular space (28) is so formed near the upper edge (48) of the inlet opening (40) that it substantially registers with the contour of the wave surface (24) of the annular piston (18) when the rearward control edge (52) of a control pocket (38) reaches the forward edge (42) of the inlet opening (40).

4. A rotary piston pump according to claim 3 further characterized in that the lower edge of (46) of the inlet opening (40) remote from the wave surface (26) of the annular space (28) follows at least substantially the movement path of the forward lower corner of a control pocket (38) with the movement of the piston (18) from the upper dead center to the lower dead center.

5. A rotary piston pump according to one of claims 1 to 4 further characterized in that the width of the inlet opening (40) measured in the circumferential direction of the annular piston (18) and the width of the control pockets (38) are so related to one another that the inlet opening (40) is open during the complete stroke of the annular piston (18) between the upper dead center and the lower dead center.

6. A rotary piston pump according to one of claims 1 to 5, further characterized in that the rear edge (58) of the outlet opening (56) is oriented at least substantially parallel to the axis, that a first section (60) of the upper edge of the outlet opening (56) adjacent to the rear edge (58) of the outlet opening (56) is arranged parallel to the wave surface (24) of the annular piston (18) when the forward control edge (50) of a control pocket (38) reaches the rear edge (58) of the outlet opening (56), and that a second section (62) of the upper edge of the outlet opening (56) connected to the first section (60) follows the contour of the control pocket edge when the annular piston reaches the upper dead center.

7. A rotary piston pump especially according to one of claims 1 to 6, further characterized in that two annular space/annular piston arrangements are arranged coaxially relative to one another, so that the pistons are arranged on the same shaft (22) and move in common between the end surfaces (26) of the two annular spaces (28, 30), that the two annular spaces (28, 30) are connected with one another by way of a fluid connection (32) lying radially within the annular piston, and that the radially inner wall of each annular space (28, 30) is formed by the outer surface of a control sleeve (34, 36), which control sleeves are arranged rotatably fixed but axially slidable in the housing (10) and are movable by a control drive between an axially inner position in which they close the fluid connection (32) and an axially outer position in which they at least partially open the fluid connection.

8. A rotary piston pump according to claim 7 further characterized in that the control sleeves (34, 36) are steplessly adjustable between their axially inner and axially outer end positions.

9. A rotary piston pump according to claim 7 or 8 further characterized in that the control sleeves (34, 36) each have at least one control slot (64) oriented parallel to the axis.

10. A rotary piston pump according to one of claims 1 to 9 further characterized in that the inlet opening and the outlet opening (40,56) are each formed in the radially outer wall of the annular space (28, 30).

11. A rotary piston pump according to one claims 1-10 further characterized in that the annular piston is formed as a one piece double piston (18).

12. A rotary piston pump especially according to one of claims 1-11 further characterized in that under the assumption that in one rotation of the piston the apex point of the piston contour (E)—in considering one development—follows the function y=cos x, where y is the axial stroke of the piston and x is the rotation angle of the piston, the contour (D) of the wave surface (26) of the annular space (28)—in considering one cycle—lies within a region enclosed by the functions
$$y = cos x and y = cos ( x - arccos \sqrt{\frac{cos x + 1}{2}} ) + \sqrt{\frac{cos x + 1}{2}} - 1$$
where the contours (E, D) of the two wave surfaces (24, 26) which slide on one another are so chosen so that the wave surfaces (24, 26) at least in the region in which they are guided by one another or engage one another with the piston rotation are continuous.

13. A rotary piston pump according to claim 12, further characterized in that the contours (E, D) of the two wave surfaces (24, 26) which slide relative to one another are so chosen in that in the wear critical area, where the apex point of the piston contour and the apex point of the contour wave surface of the annular spaces sweep over one another, the sum of the wear of the surfaces guided relative to one another is as low as possible.

14. A rotary piston pump especially according to one of claims 1-11, further characterized in that the wave surface (F) of the annular piston in the area of the apex point of a wave crest is supported by a rolling body (66) which extends outwardly beyond the wave surface (F), which rolling body is supported by a rotational axis directed radially to the piston axis and in that the contour (G) of the wave surface of the annular space is so chosen that—in consideration of one cycle—the support middle point (68) of the roll body (66) runs on the curve (H) given by the function Y_{y}=A ·cos x and in that the engagement point between the annular piston and end face of the annular space during one piston revolution constantly lies on the circumference of the rolling body.

15. A rotary piston pump according to claim 14 further characterized in that the contour (G) of the wave surface of the annular space is given by a line whose spacing from the path curve (H) of the support middle point (68) of the rolling body (66) as described by the function y=A ·cos x at each point is equal to the rolling body radius (R).
